(19) United States
(12) Patent Application Publication
(10) Pub. No.: US 2020/0269740 A1
(43) Pub. Date: Aug. 27, 2020

(54) AUTOMOBILE CUP HOLDER CONDIMENT ADAPTOR

(71) Applicant: Joshua E. Klicker, Pittsburgh, PA (US)

(72) Inventor: Joshua E. Klicker, Pittsburgh, PA (US)

(21) Appl. No.: 16/800,509

(22) Filed: Feb. 25, 2020

Related U.S. Application Data
(60) Provisional application No. 62/809,967, filed on Feb. 25, 2019.

(51) Int. Cl. B60N 3/10

(52) U.S. Cl. CPC B60N 3/103

(57) ABSTRACT

A disposable adaptor for built-in automobile cup holders to securely support condiment containers comprises a circular body sized for receipt within a conventional automobile cup holder and having a opening therein configured for receipt of a condiment container. The adapter is preferably a planar one piece cardboard construction. The opening is generally centered on the circular adapter. The circular body may further include a plurality of ears projecting outward from the circular body in equidistant positions and configured to engage the sides of the cup holder.

### RELATED APPLICATIONS

This application claims the benefit of Provisional Application Ser. No. 62/809,967 filed Feb. 25, 2020 titled “Automobile Cup Holder Condiment Adaptor”, which application is incorporated herein by reference.

### BACKGROUND OF THE INVENTION

### Field of the invention

The present invention pertains to an adaptor for built-in automobile cup holders to securely support condiment containers.

### Background Information

Built-in cup automobile holders began to be available as early as the 1920s. The development of the drive-in restaurant was a big step in the automobile cup holder's development. Servers would attach a tray that hooked over the car's side window, which needed to be left up a little for it to attach to. This gave a temporary table to hold drinks and food while eating in the car. The terms automobile, auto, vehicle and car are used interchangeably herein throughout. The drive-in restaurant and drive in cinema (colloquially called drive-ins) encouraged the development of built-in tray tables in automobiles.

Automobile built in food trays were formed in the folded down glove compartment lid that had indentations to hold cups, cans (as well as pistachio shells according to advertisements at the time) in the 1957 Chevrolet Bel Air. These trays were sufficient to hold beverages when the car was stopped, but not while the automobile was in motion. The later development of the drive-through restaurant encouraged the development of better automobile holders for drinks, and a more fast-paced life and longer commute times made many drivers desire to drink their morning coffee in the car on the way to work.

The minivans style of automobile is often cited as a pioneer for the automobile cup holder due to their wide availability in such vehicles, and outside of touring type buses, minivans still offer the greatest number of built-in cup holders.

Over time, automotive cup holders have become larger and more sophisticated so that they can hold a variety of different cup sizes securely. Many offer spring-loaded holders that clasp the cup securely, no matter how large or small. The installation of cup holders in automobiles increased significantly after events reflected in an infamous lawsuit, Stella Liebeck v. McDonald's Corporation, in which a 79-year-old woman in Albuquerque, New Mexico ordered hot coffee from a McDonald's restaurant and, when it spilled, was scalded so severely she required skin grafts. In her suit against McDonald's the jury awarded her $2.7 million in damages, later reduced by the judge to $640,000, and before the inevitable appeal could be heard, the case was settled privately for an undisclosed sum. It has been suggested that many United States vehicle shoppers consider the design, location and number of cup holders in a vehicle to be one of the most important attributes influencing their vehicle purchase.

According to market research firm The NPD Group, customers made 12.4 billion trips through fast food drive-thus in 2011 and 2012. QSR and Insula Research estimate that about 50 to 70 percent of fast food sales arrive courtesy of drive-thru windows. The numbers evidence that the built-in cup holder in a vehicle is an often used component of the vehicle.

The built-in cup holders do not accommodate all shapes of conventional food containers, and there is some difficulties in having them adequately receive all beverage containers. There have been efforts to develop inserts to broaden the application of built-in automobile cup holders.

U.S. Pat. No. 6,099,062 to Siegal teaches a cup-holder insert with a cylindrical bottom and a square top cavity. When inserted into a conventional cup-holder, the cup-holder then becomes suitable for supporting a square beverage carton or other square food container.

U.S. Patent Publications 2002-0043603 and 2003-0141424 provide a cup-holder insert which are intended to make an ordinary automobile cup-holder, for example, suitable for holding a cup as well as a snack, such as a conventional french-fry container, and in some embodiments a combo meal including a drink, french-fry container and a sandwich such as a hamburger. The cup-holder insert is consisting essentially of: a) a support member of generally circular cross-section configured to be disposed in a cup-holder and reside vertically in the cup-holder when placed therein and which defines a first cavity adapted to receive a cup and a first laterally projecting food receptacle food portion which projects laterally from said support member when the insert is placed in the cup-holder, the first laterally projecting food receptacle portion defining a second cavity adapted to receive victuals or containers therefore.

As more and more fast food restaurants are creating foods that lend themselves to dipping sauce there is a growing desire to use dipping sauce when traveling. Today there are few ideal options for the utilization of that sauce/condiment in a vehicle, which generally is in a rectangular container. Users cannot easily place them on dashboards, consoles or within existing cup holders. All natural options either lend themselves to spills/mess or create an awkward user experience. Additionally all existing adaptations require attachments, or otherwise permanent/semi-permanent fixtures. In short there is not a quick, easy and neat option for enjoying, within a vehicle, the growing amount of sauce/condiment options being offered to today's fast food customers.

The above representative solutions of the prior art are relatively complex and costly alternatives which hinders their adoption and does not address the needs of certain containers, namely certain condiments that generally come in rectangular packages. There remains a need in the art for a cost effective efficient vehicle cup holder adapter for receiving certain condiment containers.

### SUMMARY OF THE INVENTION

The object of the present invention is achieved according to one embodiment of the present invention by providing a disposable adaptor for built-in automobile cup holders to securely support condiment containers comprises a circular body sized for receipt within a conventional automobile cup holder and configured to have an opening therein configured for receipt of a condiment container.

The adapter according to the invention may include wherein the adapter is a planar one piece cardboard construction. The adapter according to the invention may include wherein the opening is centered on the circular adapter.

The adapter according to one embodiment of the present invention provides wherein the circular body has a diameter of about 3¼″, and wherein the opening is a rectangular opening that has a size of 2 1/16″×1 9/16″. The thickness of a cardboard adaptor may be about 1/16″.

The adapter according to an alternative embodiment of the present invention provides wherein the circular body further includes a plurality of ears projecting outward from the circular body in equidistant positions and configured to engage the sides of the cup holder.

In summary the invention consists of a circular disk made from cardboard, plastic or other material which rests in a vehicles existing cup-holder. This disk permits the placement of a sauce or condiment container in a suspended state within the cup holder. Once placed in the disk the sauce/condiment can be utilized by a driver or passenger.

The features that characterize the present invention are pointed out with particularity in the claims which are part of this disclosure. These and other features of the invention, its operating advantages and the specific objects obtained by its use will be more fully understood from the following detailed description.

### BRIEF DESCRIPTION OF THE FIGURES

FIG. 1 is a side perspective view of a disposable adaptor for built-in automobile cup holders to securely support rectangular condiment containers in accordance with a first embodiment of the present invention;

FIG. 2 is a top plan view of the disposable adaptor of FIG. 1;

FIG. 3 is a top plan view of a disposable adaptor for built-in automobile cup holders to securely support rectangular condiment containers in accordance with a second embodiment of the present invention;

FIG. 4 is a top plan view of a disposable adaptor for built-in automobile cup holders to securely support circular condiment containers in accordance with a third embodiment of the present invention;

FIG. 5 is a side perspective view of the disposable adaptor of FIG. 4;

FIG. 6 is a top plan view of a disposable adaptor for built-in automobile cup holders to securely support condiment containers in accordance with a fourth embodiment of the present invention.

FIG. 7A is a top plan view of a disposable adaptor for built-in automobile cup holders to securely support circular condiment containers in accordance with a fifth embodiment of the present invention.

FIG. 7B is a top plan view of a disposable adaptor for built-in automobile cup holders to securely support rectangular condiment containers in accordance with a modified version of the fifth embodiment of the present invention.

### DESCRIPTION OF THE PREFERRED EMBODIMENTS

As discussed above with billions of drive-thru trips every year the utilization of the built-in automobile cup holder is high. Further as noted above the cup holders currently are not well designed for receipt of non-circular food containers.

Fast food companies establish benchmark measures to evaluate their performance in servicing customers in the drive-thru window. Measures include the average time to service a customer; the accuracy of the order; the appearance of the restaurant, such as the exterior, landscaping, dumpsters and cleanliness of menu board; the customer experience, including customer service attitude; the clarity of the speaker; whether the location contains an order confirmation board; and the methodology used to service customers. The present invention is directed to improving customer experience at drive-thrus, in particular with customer experience in handling condiments in small rectangular or small circular containers. The term “small” referencing that they have a smaller footprint than a conventional automobile cup holder. The present invention is, of course not limited to drive-thru usage, but that is the implementation that designs of the present invention are centered around.

The present invention is directed to condiments that are found in rectangular or circular packages. One typically version is with a rectangular (in top or plan view) plastic container having a surrounding flange at the top to which a peel off foil is secured. One common example is found in the “dipping sauces” that are provided with chicken nuggets or strips. Another typical version is a circular plastic container (in top or plan view) having a surrounding flange at the top to which a peel off foil is secured, and this too is often used to supply dipping sauces or ketchup.

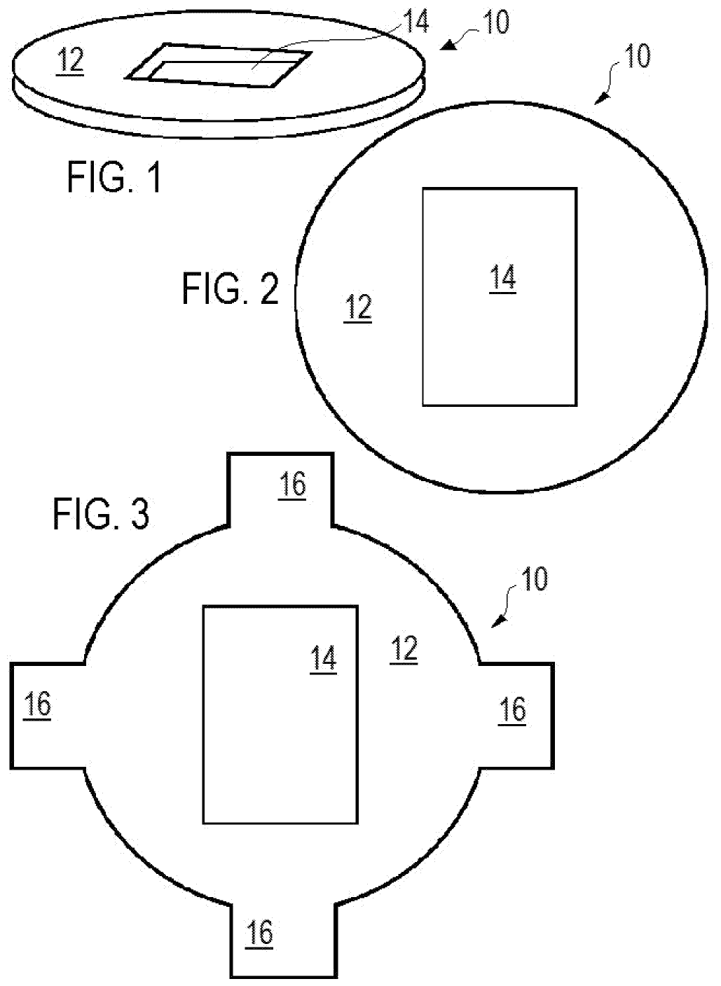

The present invention, in accordance with one embodiment shown in FIGS. 1-2, provides a disposable adaptor 10 for built-in automobile cup holders to securely support rectangular condiment containers comprises a circular body 12 sized for receipt within a conventional automobile cup holder and having a rectangular opening 14 therein configured for receipt of a rectangular condiment container.

The adapter 10 according to the embodiment of FIGS. 1 and 2 provides that the adapter 10 is a planar one piece cardboard construction. The one piece cardboard construction of adaptor 10 yields a device that is easy and economical to be made disposable by the user and allows the restaurants chain to easily absorb the costs to improve customer experience. For a cardboard version of the adaptor 10 the thickness is about 1/16″. Further, the planar construction allows the adaptors 10 to be efficiently stacked for space saving storage in the restaurant drive thru and improved shipping. Plastic is also possible and cost effective (similar to fast food beverage cup lids), but cardboard yields environmental advantages. The ability of the costs to be absorbed easily by a fast food chain allows the adaptor 10 to have the opening 14 sized specifically for the brand of condiment container they utilize (although the condiment container size is found to be somewhat standardized in the industry).

In operation at a conventional drive-thru, the adapter 10 is handed to the customer who may be able to utilize the adapter 10 with the rest of his meal. Obviously the adaptor 10 is not needed for every customer and is only applicable for those receiving the associated rectangular condiment containers that matches the opening 14. Further, even with those customers that are receiving such condiments, the number of adapters 10 is not expected to always match the number of such condiments in a given order. It is also anticipated that the restaurant worker actually places one of the condiment containers within the opening 14 of an adapter 10 and places this adapter 10 with coupled condiment in the customer's bag to further improve the customer experience.

How the adapters 10 are given out to customers is obviously up to the discretion of the individual restaurants. For example it may be only upon request, or one adaptor 10 for every order having a relevant condiment, it may include placing the condiment container within the adapter 10 for the customer. It is solely up to the desired customer-restaurant relations, and the desired customer experience.

The adapter 10 according to the embodiments of the invention is formed wherein the opening, such as the rectangular opening 14 of FIGS. 1 3, is centered on the circular adapter 10. Centering the opening 14 is desired to prevent unbalanced loading and introducing instability in the system (e.g., the adaptor and open condiment mounted within a cup holder) due to a moment being created by the user. However an adapter 10 with multiple openings 14 that are offset is certainly possible, but the single centered opening 14 is preferred.

The adapter 10 according to the preferred embodiments of FIGS. 1 and 2 includes wherein the circular body has a diameter of about ¾″ and wherein the rectangular opening has a size of about 2 1/16″×1 9/16″. These sizes are to conform to conventional automobile cup holder sizes and rectangular condiment container sizes and can vary depending upon cup holder variances and condiment container variances.

FIG. 3 is a top plan view of a disposable adaptor 10 for built-in automobile cup holders to securely support rectangular condiment containers in accordance with a second embodiment of the present invention. The adapter 10 according to this modified embodiment is provided wherein the circular body 12 with centered rectangular opening 14 further includes a plurality of ears 16 projecting outward from the circular body 12 in equidistant positions and configured to engage the sides of the cup holder. The ears 16 will “fold up” when in contact with the sides of the cup holder and yields a secure attachment and allows the adapter 10 to fit a range of cup holder sizes defined largely by the length of the ears. Any plurality of ears 16 may be used but three or four equidistant ears 16 are most desirable. The ears 16 may also be described as friction fit tabs for the adapter 10.

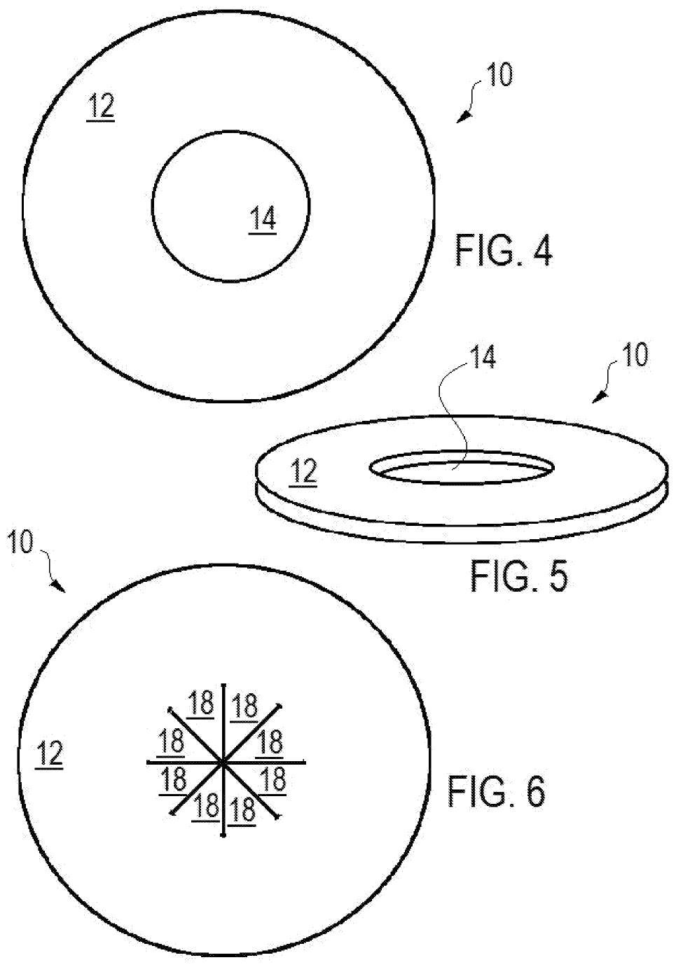

The opening 14 in the adaptor 10 can be alternatively sized for the desired condiment container. For example some dipping sauces are formed in a circular container and FIGS. 4-5 show a disposable adapter 10 formed for such sauces. Specifically these show a disposable adaptor 10 for built-in automobile cup holders to securely support circular condiment containers comprises a circular body 12 sized for receipt within a conventional automobile cup holder and having a circular opening 14 therein configured for receipt of a circular condiment container.

FIG. 6 is a top plan view of a disposable adaptor 10 for built-in automobile cup holders to securely support condiment containers in accordance with a fourth embodiment of the present invention. In this embodiment the pre-formed opening 14 is replaced with cut lines defining condiment engaging triangular fingers 18 in the opening space (not numbered in this embodiment—formed with the container in place) that can engage the condiment container. The condiment container engaging triangular fingers 18 are surrounding the opening space that receives the condiment container therein and the fingers 18 directly and frictionally engage the condiment container. This construction allows the opening to accept a range of generally circular condiment containers.

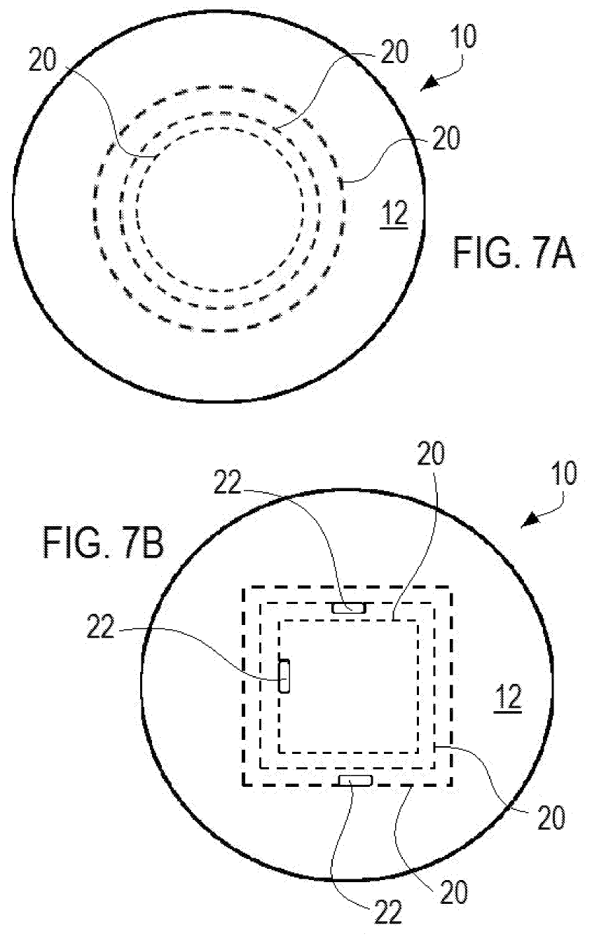

In the embodiments of the invention of FIGS. 1-5 the openings 14 are considered pre-formed in the respective adaptor 10, whereas in the embodiment of the adaptor 10 shown in FIGS. 6 and 7A and 7B the opening in the body 12 engaging the condiment container is formed by the user (the customer or the drive thru worker) and thus not “pre-formed”, but rather user formed.

The arrangement of fingers 18 shown in FIG. 6 are well suited for circular condiment containers of a range of shapes, but could receive other shapes like oval or even rectangular. However, a specific rectangular opening could be lined with similar triangular shaped container engaging fingers to allow for use with a small range of rectangular containers as well. This is just to evidence some of the variations available within the spirit and scope of the present invention.

FIG. 7A is a top plan view of a disposable adaptor 10 for built-in automobile cup holders to securely support circular condiment containers in accordance with a fifth embodiment of the present invention. In this embodiment the center is formed with two or more scored outlines 20 corresponding to condiment container sizes. In this embodiment the condiment container is pressed through the body 10 within the scored lines 20. The body 12 will separate along the scored line 20 that corresponds to the size of the container and a central opening will be formed corresponding to the particular condiment container. This embodiment of FIG. 7A, like the embodiment of FIG. 6, also allows a single adaptor to be used with a small range of condiment container sizes. The person pushing the container through the body 12 and using the desired score lines 20 may be the customer or the drive thru worker, although having it be the drive thru worker offers certain advantages. If the drive thru operator pushes the condiment container through the desired score line 20 to form the appropriate opening they can throw away the scrap that is formed minimizing unwanted clutter and waste for the consumer. Further, although this adapter 10 is not particularly difficult to operate, the drive thru worker will develop a certain amount of skill in operation through the repetition that would be hard for the consumer to match, and the adaptor 10 of the present invention is intended to maximize the consumer experience.

FIG. 7B is a top plan view of a disposable adaptor for built-in automobile cup holders to securely support rectangular (or square) condiment containers in accordance with a modified version of the fifth embodiment of the present invention. Here the circular condiment opening forming score lines of the embodiment of FIG. 7A are replaced with rectangular (in particular square) shaped score lines 20 that accommodate a small range of rectangular condiment containers. Additionally the body 12 includes fingernail openings 22 associated with select score lines 20 that allows the user to stick a fingernail in and grasp and tear out or remove center portion of the body 12 to form the opening along the appropriate condiment container matching score line 20. The user may still opt to “push” the condiment container through the body 12 as discussed above in connection with FIG. 7A, but the user may also elect to peel off, or peel out, the desired opening size.

The features of the adaptors 10 of the specific embodiments shown above are not limited to the embodiments shown therein, but may be “mixed and matched”. For example, as noted above the fingers 18 may be formed around a rectangular opening. Further the ears 16 of the embodiment of FIG. 3 could easily be implemented with the embodiments of FIG. 4-5, 6 or 7A or 7B.

It will be apparent to those of ordinary skill in the art that various changes may be made to the present invention without departing from the spirit and scope thereof. The spirit and scope of the present invention is defined in the appended claims and equivalents thereto.

What is claimed is:

1. A disposable adaptor for built-in automobile cup holders to securely support rectangular condiment containers comprises a circular body sized for receipt within a conventional automobile cup holder and configured to have an opening therein configured for receipt of a condiment container.

2. The adapter according to claim 1 wherein the adapter is a planar one piece cardboard construction.

3. The adapter according to claim 2 wherein the opening is centered on the circular adapter.

4. The adapter according to claim 3 wherein the opening is pre-formed in the circular adapter.

5. The adapter according to claim 4 wherein the circular body has a diameter of about 3¼″.

6. The adapter according to claim 5 wherein the preformed opening is a rectangular opening that has a size of about 2 1/16″×1 9/16″.

7. The adapter according to claim 2 wherein the circular body further includes a plurality of ears projecting outward from the circular body in equidistant positions and configured to engage the sides of the cup holder.

8. The adapter according to claim 7 wherein the opening is centered on the circular adapter.

9. The adapter according to claim 8 wherein the opening is pre-formed in the circular adapter.

10. The adapter according to claim 9 wherein the circular body has a diameter of about 3¼″.

10. The adapter according to claim 9 wherein the preformed opening is a rectangular opening that has a size of about 2 1/16″×1 9/16″.

11. The adapter according to claim 2 further including condiment container engaging triangular fingers surrounding the opening space wherein the fingers engage the condiment container.

12. The adapter according to claim 11 wherein the opening is centered on the circular adapter.

13. The adapter according to claim 12 wherein the circular body has a diameter of about 3¼″.

14. The adapter according to claim 2 further including a plurality of scored outlines in the body corresponding to condiment container sizes wherein the body is configured to separate along the scored line that corresponds to the size of the container and a central opening will be formed corresponding to the particular condiment container.

15. The adapter according to claim 14 wherein the score lines are centered on the circular adapter.

16. The adapter according to claim 15 wherein the circular body has a diameter of about 3¼″.

17. The adapter according to claim 1 wherein the opening is centered on the circular adapter.

18. The adapter according to claim 17 wherein the opening is pre-formed in the circular adapter.

19. The adapter according to claim 18 wherein the circular body has a diameter of about 3¼″.

20. The adapter according to claim 19 wherein the preformed opening is a rectangular opening that has a size of about 2 1/16″×1 9/16″.
